(19) United States
(12) Patent Application Publication
(10) Pub. No.: US 2017/0046753 A1
(43) Pub. Date: Feb. 16, 2017

(54) PROVISIONING AN INTERACTIVE FEEDBACK SERVICE VIA A NETWORK

(71) Applicant: Evershare, LLC, Mount Pleasant, SC (US)

(72) Inventor: William J. Deupree, IV, Mount Pleasant, SC (US)

(73) Assignee: Evershare, LLC, Mount Pleasant, SC (US)

(21) Appl. No.: 15/306,347

(22) PCT Filed: Apr. 24, 2015
(86) PCT No.: PCT/US2015/027444

§ 371 Date: Oct. 24, 2016

Related U.S. Application Data
(60) Provisional application No. 61/983,562, filed on Apr. 24, 2014.

(51) Int. Cl. G06Q 30/02; H04L 29/08

(52) U.S. Cl. CPC G06Q 30/0282; H04L 67/18

(57) ABSTRACT

A system includes one or more processors executing one or more instructions to: receive, from a user device, a request to provide feedback. The feedback may include information associated with an opinion of a user, of the user device, in connection with a particular product, service, or particular provider. The system may also obtain information associated with a group of providers; output, to the user device, the information, associated with the group of providers, to enable the user to select a provider to which the feedback is to be transmitted; receive, from the user device, information that identifies a selection of the provider; and output the feedback to a different server device associated with the selected provider based on the information that identifies the selection of the provider.

### BACKGROUND

User devices and other computational and/or communication devices (e.g., tablet computers, laptop computers, desktop computers, etc.) are capable of performing an increasing variety of functions and tasks that continue to improve the user's experience. For example, user devices can run a variety of applications, can connect to a variety of wired and wireless networks to receive services, can access a variety of services and/or perform various functions associated with ecommerce, point of sale transactions, social networking, downloading and uploading content, sending and receiving messages, etc.

Many businesses, organizations, or associations provide websites, services or applications via which users can provide feedback regarding products or services offered by the businesses, organizations or associations. Such feedback may identify whether a user likes or dislikes a product or service, the degree to which the user likes or dislikes the product or service, or a particular feature of the product or service that the user likes or dislikes. A particular website, service or application may be hosted by a server device with which a particular business, organization, association, etc. is associated. The user may use a user device to communicate with the server device to provide the feedback. In the event that the business, organization, association, etc., does not maintain a website, service, or application, the user may not be able to provide the feedback regarding the product or service. Furthermore, in the event that the user desires to leave feedback regarding a variety of different products or services obtained from different businesses, organizations, association, etc., the user may use the user device to access, on an individual basis, each website, service, application, etc. to leave feedback regarding each of the different products or services, which can be cumbersome for the user.

### SUMMARY

According to one implementation, described herein, a server device may include one or more processors executing one or more instructions to receive, from a user device, a request to provide feedback. The feedback may include information associated with an opinion of a user, of the user device, in connection with a particular product, a particular service, or a particular provider. The server device may include one or more processors to obtain, based on receiving the request, information associated with a group of providers; output, to the user device, the information, associated with the group of providers, to enable the user to select a provider, of the group of providers, to which the feedback is to be transmitted; receive, from the user device and based on outputting the information associated with the group of providers, information that identifies a selection of the provider; and output the feedback to a different server device associated with the selected provider based on the information that identifies the selection of the provider.

According to another implementation, described herein, a system may include one or more server devices executing one or more instructions to receive, from a user device, a request to provide feedback. The feedback may include information associated with an opinion of a user, of the user device, in connection with a product, a service, or a provider of products or services. The system may also include one or more server devices to obtain, based on the request, information identifying a location associated with the user device; retrieve information associated with a group of providers that are located within proximity of the location of the user device, based on the information identifying the location of the user device; output, to the user device, the information associated with the plurality of providers; and receive, from the user device, feedback associated with a selected provider, of the group of providers. The selected provider may be selected, by the user, from the information associated with the group of providers. The system may further use the one or more server devices to output the feedback to a different server device associated with the selected provider.

According to yet another implementation, described herein, a method performed by a first server device executing one or more instructions may include receiving, by the first server device and from a user device, a request to provide feedback to a second server device associated with a provider that offers a product has been accessed by a user of the user device; obtaining, by the first server device and based on the request, a first keyword associated with the feedback or information identifying a location associated with the user device; obtaining, by the first server device, information associated with a group of providers that include a second keyword that matches the first keyword or are located within a geographical area in which the location of the user device is located; transmitting, by the first server device and to the user device, the information associated with the group of providers that are located within the geographical location; receiving, by the first server device and from the user device, feedback associated with a selected provider, of the group of providers, the feedback describing an opinion of the user with respect to the product or the service. The method may also include processing, by the first server device, the feedback based on at least one of: a rating of the product or the service that is provided by the user and is included within the feedback, or one or more keywords included within the feedback that match other keywords stored in a memory associated with the first server device. The keywords may describe the opinion of the user with respect to the product or the service. The method may further include assigning, by the first server device, one or more scores to the feedback based on processing the feedback; transmitting, by the first server device and to the second server device, at least one of: the feedback, the one or more scores, or the keywords that match the other keywords that are stored in the memory.

### DESCRIPTION BRIEF DESCRIPTION OF THE DRAWINGS

FIG. 1 is a diagram of an example environment in which the systems, methods, apparatus, technologies, and/or techniques, described herein, may be implemented;

FIG. 2 is a diagram of example components of one or more of the devices of FIG. 1;

FIG. 3 is a diagram of an example framework that may be associated with an application being hosted and/or executed by an application server of FIG. 1;

FIG. 4 is a flow chart of an example process that may be used to register one or more devices of FIG. 1 according to an implementation described herein;

FIG. 5 is a diagram of an example user interface that may be used to set up or register a server device associated with a provider identified in FIG. 1;

FIG. 6A is a flow chart of an example process that may be used to provide feedback by a user device according to an implementation described herein;

FIG. 6B is a diagram of an example user interface that may be displayed on user device of FIG. 1 and/or used to provide feedback to a selected provider;

FIG. 7 is a flow chart of an example process that may be used to process feedback received from a user device to create analytics associated with a provider;

FIG. 8 is a diagram of an example user interface via which information associated with feedback, received from one or more user devices, may be displayed;

FIG. 9 is a flow chart of an example process that may be used to create comparative analytics associated with a provider; and

FIG. 10 includes an example user interface that may identify aggregate analytics between two or more providers.

### DETAILED DESCRIPTION

The systems, methods, technologies, and/or techniques (hereinafter referred to as the “systems and/or methods”), described herein, may enable a user, of a user device, to access an application (hereinafter, a “feedback application”), hosted on and/or being executed by the user device, that can be used to provide feedback to a server device, with which a provider is associated (hereinafter, “provider server”) regarding a good or service offered by the provider. The feedback may take any of a number of different forms, such text-based feedback, audio content that includes spoken feedback from the user, a document uploaded by the user, an image that includes a visual representation of the feedback, video content of the user providing feedback, or some combination thereof. The user device may transmit the feedback to an application server on which the feedback application may also, or alternatively, be running, for delivery to the provider server.

In one example, feedback in any medium (e.g., text, an image, a video recording, an audio recording, a document, etc.) may be transmitted by the user device using an electronic mail protocol, a hypertext transfer protocol (HTTP), a short message service (SMS) protocol, an instant message (IM) protocol, or some other message or email protocol. Additionally, or alternatively, spoken or video feedback may be translated to text or some other format by the user device (e.g., using the feedback application or some other application) and transmitted to the application server. Additionally, or alternatively, the spoken and/or video feedback may be transmitted, by the user device, to the application server as audio and/or video content and the application server may translate the audio and/or video content to text for processing and/or forwarding to the provider server.

The term provider, as used herein, may include any business, association, agency, organization, charity, religious organization, governmental entity, political subdivision, person, etc. that offers or provides a good or service, information, communicates publically, or maintains an online presence. A non-exhaustive list of example providers may include restaurants, retailers, hotels, municipalities, elected officials, corporations, non-profits, churches, medical providers, service providers, educational institutions, franchises, and/or individuals.

The systems and/or methods may also, or alternatively, enable the user device to access a service (hereinafter a “feedback service”), provided by an application server on which the feedback application is hosted and/or being executed, that permits the feedback to be provided to the application server. The application server may receive the feedback, process the feedback (e.g., to convert the feedback to a supported data format, convert to text, generate feedback analytics, create aggregate feedback, etc.), and/or transmit the received and/or processed feedback to the provider server.

A copy of the feedback application may be hosted on and/or executed by the application server, the user device, the provider server, or some combination thereof. The systems and/or methods may cause a user interface to be displayed on the user device that identifies one or more providers from which the user may, with a single selection (e.g., a single click of a mouse, track ball, single touch of a touch screen, single button on a keyboard, by speaking a word, etc.), select a particular provider for which to provide the feedback. The one or more providers may be identified by the user device and/or application server based on a location of the user device relative to a particular distance or geographical area within which the providers are located relative to the location of the user device. The one or more providers may also, or alternatively, be identified by the user (e.g., based on a selection from a list of providers, a search query provided by the user, a provider name, identifier, etc. provided by the user, etc.). The one or more providers may also, or alternatively, be selected from a list of providers.

Additionally, or alternatively, the systems and/or methods may cause a different user interface to be displayed on the user device via which the user may identify a product or service, enter feedback, answer a question, pose a question, fill out a survey, provide or select a review, join a group, upload text, upload images or video, etc.

The systems and/or methods may provide information associated with one or more businesses to a user device. The information, associated with one or more businesses, may be provided by the one or more provider that have subscribed to the application server. Additionally, or alternatively, the information associated with the one or more businesses may be obtained from a database that stores such information without regard to whether the one or more providers have subscribed to the application server. The information, associated with the one or more providers, may identify names or identifiers of the providers, products or services provided by the providers, locations of the providers, contact information of the providers, subscription levels of the providers, etc.

The systems and/or methods may store the feedback with other feedback that has been provided by the user or other users and may track a usage history associated with the user (e.g., quantity of times feedback has been left, providers for which feedback is targeted, types of goods or services accessed by user, frequency of use of the feedback application, whether the user is a super user with respect to a business, etc.). The user may use the feedback application to identify one or more favorite providers or most frequented providers by the user and may provide information, to the user device, associated with the a promotion, advertisement, surveys, etc. offered by the favorite providers. The systems and/or methods may cause a notification, associated with a business, to be provided to the user device based on a determination that the user device is associated with a group with which the provider is associated, is located on the provider premises, is leaving the provider premises, or is entering the provider premises.

The systems and/or methods may enable a provider to register a provider server with the application server that enables the provider server to access (e.g., via an application programming interface (API) with the application server) one or more feedback services and/or receive actual or aggregated feedback, via the application server, from a user device and/or group of user devices. In this example, the feedback services may include feedback analytics that includes information and data that identifies the quantity and/or frequency of feedback, products or services for which feedback is provided, locations from which feedback is provided, a sentiment associated with particular feedback (e.g., excellent, very good, good, fair, poor very poor, etc.), a review (e.g., one-star, two-stars, three-stars, etc.) associated with particular feedback, etc. The systems and/or methods may provide aggregated feedback from two or more users (e.g., average sentiment, average reviews, frequency of feedback, etc.), feedback trends based on whether average sentiment, frequency/quantity of feedback, reviews, etc. is increasing, decreasing or staying the same, etc. The systems and/or methods may score the feedback and/or aggregated feedback based on the sentiment, reviews, frequency of feedback, etc. Additionally, or alternatively, all or a portion of the aggregated feedback and/or feedback analytics, associated with a business, may be accessible to a user device to enable a user, of the user device, to view feedback regarding a provider from one or more other users of other user devices.

The systems and/or methods may also, or alternatively, enable the application server to create and/or transmit comparative feedback analytics to the provider server, that identifies feedback for a particular provider, with which the provider server is associated, relative to other feedback provided to a different provider server associated with which a different provider (e.g., a peer business or entity, such as a competitor, partner, etc.). The comparative feedback analytics may be based on comparative scores assigned to the feedback or other feedback, relative differences in sentiment, reviews, feedback trends, etc. The comparative feedback analytics may also, or alternatively, enable a provider to track and/or monitor respective feedback received relative to each of one or more branches of the provider (e.g., locations, franchises, branches, departments, etc.) to identify and/or rank branches that are receiving feedback associated with a particular score, sentiment, review, etc. relative to other branches with lower or higher scores, more positive or negative sentiment, better or worse reviews, etc. Additionally, or alternatively, all or a portion of the comparative feedback analytics, associated with a provider or branch or parent thereof, may be accessible by a user device to enable, for example, a user, of the user device, to compare one or more providers or branches based on the comparative feedback analytics.

The systems and/or methods may, based on the feedback analytics, enable the provider to identify a preferred user (e.g., a fan or patron that is frequent purchaser, provides frequent feedback, leaves particularly thorough or positive feedback, etc.) and/or may cause the provider server provide a promotion to a user device associated with the preferred user (e.g., via the application server). The systems and/or methods may enable the provider server to provide a promotion (e.g., a coupon, discount, an apology, an invitation to return, etc.) to a user device from which particularly negative feedback pertaining to the provider was received (e.g., via the application server). The system and/or methods may enable the application server and/or provider server to detect particular keywords and/or to provide an alert or notification to the provider (e.g., via the provider server) indicating that a certain keyword or trend has been detected with respect to particular feedback or aggregate feedback, etc. For example, for a restaurant provider, the detection of the words “food poison” may cause the application server and/or provider server to provide an alert or notification to the provider to enable the provider to quickly respond to an actual event or attempt to mitigate conjecture, rumors, etc.

The systems and/or methods may enable the application server and/or provider server to identify and/or select particular feedback or portions thereof based on a product, feature, etc. (e.g., food quality, crash safety, etc.) that enables particular feedback to be identified (e.g., tagged, selected, stored, etc.), alerts to be provided, or analytics to be performed when feedback is associated with the tag. Additionally, or alternatively, the systems and/or methods may enable a provider server with which a provider is associated, to search, select, identify and/or access particular feedback (e.g., associated with a product or service, a time frame, a keyword, a provider or branch, one or more user devices, etc.) to permit employees to collaborate regarding the particular feedback via user devices associated with the business, that are connected to the server device. In one example, the provider may use the provider server to transmit a response to the feedback directly to a user device (e.g., via the application server) from which particular feedback is received. Additionally, or alternatively, a user, of a user device, may access particular feedback and may collaborate with other users, of other user devices, about the particular feedback. The systems and/or methods may enable such feedback to be identified (e.g., tagged, selected, stored, etc.) in a manner that enables an alert to be provided to the provider server (or user device as the case may be) indicating that additional feedback, associated with the identified feedback, has been received and/or is available for further collaboration. The systems and/or methods may enable the particular feedback, tagged feedback, feedback summaries, alerts, notifications, collaboration, aggregate or comparative feedback analytics, etc. to be accessed by a provider server associated with a provider. For example, the application server may provide the particular feedback, tagged feedback, alerts, notifications, collaboration, feedback analytics, etc. to a provider server, associated with a provider (e.g., using an email protocol, an IM protocol, a SMS protocol, a data service, etc.) when feedback is received from a user device, on demand when requested by the provider server, based on a time or time period (e.g., a time interval or time of day, daily, weekly, etc.), etc.

The systems and/or methods may enable the application server to use aggregate feedback, feedback analytics, and/or comparative feedback analytics to identify and/or analyze high-performing providers, products, or services; low performing providers products, or services; up-and-coming providers, products, or services; etc. relative to peer companies, markets, etc. The application server may make such information available for access by a user device associated with a user, a server device associated with a business, and/or a user device associated with the business

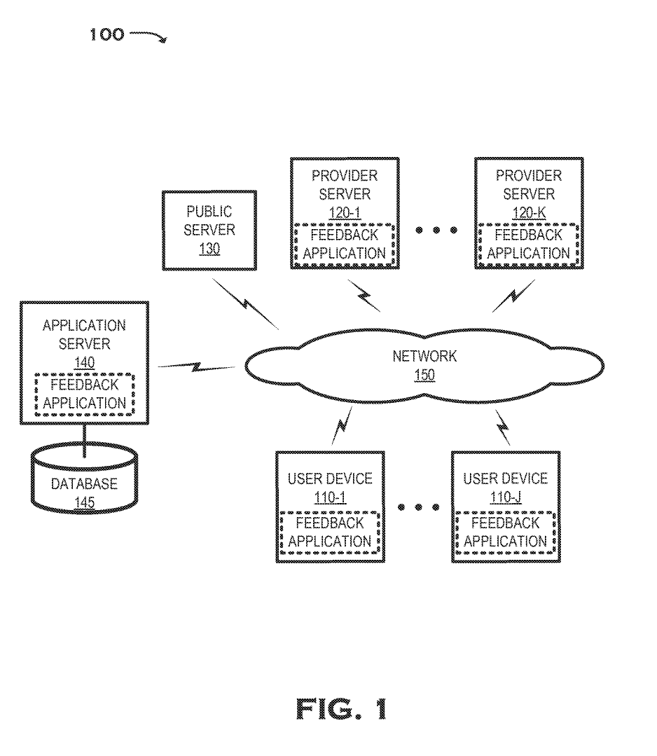

FIG. 1 is a diagram of an example environment 100 in which the systems and/or methods, described herein, may be implemented. As shown in FIG. 1, environment 100 may include a group of user devices 110-1, . . . , 1104 (collectively referred to herein as “user devices 110,” and individually as “user device 110”) (where J≧1) and a group provider servers 120-1, . . . , 120-K (collectively referred to herein as “provider servers 120” and individually as “provider server 120”) (where K≧1), a public server 130, an application server 140, a database 145, and a network 150. The number of devices and/or networks, illustrated in FIG. 1, is provided for explanatory purposes only. In practice, there may be additional networks and/or devices, fewer networks and/or devices, different networks and/or devices, or differently arranged networks and/or devices than illustrated in FIG. 1.

Also, in some implementations, one or more of the devices of environment 100 may perform one or more functions described as being performed by another one or more of the devices of environment 100. Devices of environment 100 may interconnect via wired connections, wireless connections, or a combination of wired and wireless connections.

User device 110 may include any computation or communication device, such as a wireless mobile communication device, that is capable of communicating with network 140. For example, user device 110 may include a radiotelephone, a personal communications system (PCS) terminal (e.g., such as a smart phone that may combine a cellular radiotelephone with data processing and data communications capabilities), a personal digital assistant (PDA) (e.g., that can include a radiotelephone, a pager, Internet/intranet access, etc.), a laptop computer, a tablet computer, a personal computer, a camera, a personal gaming system, or another type of computation or communication device. In one example implementation, user device 110 may include a global positioning satellite (GPS) component that communicates with a GPS constellation to provide and/or obtain location information associated with user device 110. Additionally, or alternatively, user device 110 may include logic, such as one or more processing or storage devices, that can be used to perform and/or support processing activities on behalf of a user.

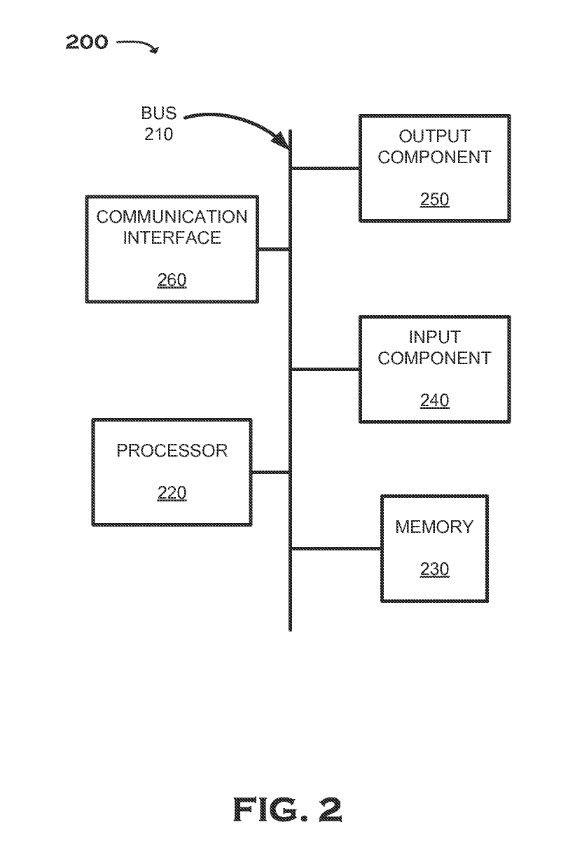

User device 110 may perform communication operations by sending data to or receiving data from another device, such as some other user device 110, provider server 120, public server 130, and/or application server 140. Data may refer to any type of machine-readable information having substantially any format that may be adapted for use in one or more networks and/or with one or more devices. Data may include digital information or analog information. Data may further be packetized and/or non-packetized. User device 110 may include logic for performing computations on user device 110 and may include the components illustrated in FIG. 2 in an example implementation.

User device 110 may host a feedback application, obtained from application server 140 and/or public server 130 (e.g., from which the application can be obtained and/or purchased), via which feedback can be provided to a particular provider server 120 with which a provider entity that provides products and/or services is associated. User device 110 may use the application to enable a first user interface to be displayed that identifies one or more business, from which the user, of user device 110, can select (e.g., using a pointing device, touching a touch screen, pressing a button on a keyboard, etc.) to leave feedback in any media, such as text, voice, video, etc. Selection of the provider may cause the feedback application to display a second user interface into which the user can enter feedback to be provided to provider server 120 associated with the provider. Additionally, or alternatively, user device 110 may not include a feedback application and may communicate with application server 140 to access a website via which a feedback service is provided to user device 110 in a manner described above and herein. Provider server 120 may include one or more server devices, or other types of computation or communication devices, that gather, process, search, store, and/or provide information in a manner described herein. Provider server 120 may communicate via network 150, to application server 140, public server 130, another provider server 120 and/or user device 110. Provider server 120 may communicate with application server 140 to register and/or obtain a copy of some or all of the feedback application that enables provider server 120 to receive feedback from user device 110, aggregate feedback from a collection of user devices 110, analytics associated with feedback from user devices 110 and/or comparative analytics relative to feedback received by one or more peer provider entities associated with other provider servers 120.

Public server 130 may include one or more server devices, or other types of computation or communication devices, that gather, process, search, store, and/or provide information in a manner described herein. Public Server 130 may communicate via network 150, to application server 140, provider server 120 and/or user device 110. For example, public server 130 may include a database of publically available provider information associated with one or more provider entities that offers products and/or services that can be accessed, consumed, purchased, used, etc. by one or more users of user devices 110. The provider information may, for example, identify a provider name, an address, branches or divisions and addresses thereof, a telephone number, products and/or services offered by the business, a web address associated with a website (e.g., in the form of a uniform resource locator (URL), etc.), an email address, the names of one or more employees, officers, executives, etc.

Application server 140 may include one or more server devices, or other types of computation or communication devices, that gather, process, search, store, and/or provide information in a manner described herein. Application server 140 may communicate via network 150, to public server 130, provider server 120 and/or user device 110. Application server 140 may register user device 110 and/or provider server 120 and/or may provide a copy of a feedback application that can be downloaded or installed on user device 110 and/or server device 120 to permit user device 110, application provider server 120, and/or other provider servers 120 to perform operations as described herein.

Application server 140 may receive feedback, intended for a business, from user device 110 and may transmit all or some of the feedback to provider server 120 associated with the business. The feedback may, for example, include information that identifies an opinion or experience that the user has regarding a business, a product and/or service offered by the business, an employee or representative of the business, a provider facility or equipment, etc. Such feedback may include text (e.g., in the form of electronic mail, text message, etc.), audio (e.g., an audio recording of the user speaking the feedback, etc.), images and/or video (e.g., an image taken and/or video recording of the user providing the feedback, etc.), a rating (e.g., based on a star rating, a number rating, a letter rating, etc.), etc. Application server 140 may process the feedback to identify keywords (e.g., typed or spoken by the user) and/or images to determine to what topic the feedback pertains (e.g., a product, service, business, facility, etc.) and/or whether the feedback is positive, neutral or negative. Application server 140 may transmit the processed feedback to provider server 120. Application server 140 may combine the feedback with other feedback received from other user devices 110 to create feedback analytics associated with provider server 120. The feedback analytics may identify a sentiment (positive, neutral, or negative) associated with the business, a product, or a service and/or may assign one or more scores to the feedback based on the sentiment, the keywords, the user rating, etc. Application server 140 may, based on the scores, determine whether the sentiment, rating and/or scores, associated with the feedback, is changing (e.g., increasing in positivity, decreasing in positivity, etc.) or remaining the same over time. Application server 140 may use the ratings, sentiment and/or the scores to compare the feedback with feedback received by a peer provider in the same or different industries as the business' industry.

Application server 140 may also, or alternatively, act as a web server 140 or some other type of webserver that hosts a website that can be accessed, by user device 110 and/or a different provider server 120, to receive one or more feedback services such as those described herein. For example, application server 140 may host a website associated with collecting (e.g., from user devices 110), processing, aggregating, and providing feedback and/or processed feedback to provider server 120 with which providers are associated. Application server 140 may process, aggregate, and/or analyze feedback from one or more user devices 110 and may generate feedback analytics based on the feedback and/or one or more providers, products, or services. Application server 140 may provide the feedback analytics to one or more provider servers 120 with which the one or more providers are associated.

Database 145 may include one or more devices that store information received from application server 140. For example, database 145 may store copies of the feedback application that are supported by and/or compatible with different types of user devices 110 and/or provider servers 120. Database 145 may store one or more profiles associated with a user device 110, provider server 120, a user, a business, etc. Database 145 may also, or alternatively, store feedback information, provider information, analytics, industry information, and/or profiles.

Network 150 may include one or more wired and/or wireless networks. For example, network 140 may include a cellular network, a public land mobile network (PLMN), a second generation (2G) network, a third generation (3G) network, a fourth generation (4G) network (e.g., a long term evolution (LTE) network), a fifth generation (5G) network, and/or another network. Additionally, or alternatively, network 150 may include a wide area network (WAN), a metropolitan network (MAN), a telephone network (e.g., the Public Switched Telephone Network (PSTN)), an ad hoc network, an intranet, the Internet, a fiber optic-based network, and/or a combination of these or other types of networks.

FIG. 2 is a diagram of example components of a device 200 that may correspond to user device 110, provider server 120, public server 130, and/or application server 140. Additionally, or alternatively, each of user device 110, provider server 120, public server 130, and/or application server 140 may include one or more devices 200. Device 200 may include a bus 210, a processor 220, a memory 230, an input component 240, an output component 250, and a communication interface 260. Although FIG. 2 shows example components of device 200, in other implementations, device 200 may include fewer components, additional components, different components, or differently arranged components than depicted in FIG. 2. Additionally, or alternatively, in other implementations, one or more components of device 200 may perform one or more tasks described as being performed by one or more other components of device 200.

Bus 210 may include a path that permits communication among the components of device 200. Processor 220 may include a processor, microprocessor, or processing logic that may interpret and execute instructions. Memory 230 may include any type of dynamic storage device that may store information and instructions for execution by processor 220, and/or any type of non-volatile storage device that may store information for use by processor 220.

Input component 240 may include a mechanism that permits an operator to input information to device 200, such as a keyboard, a keypad, a button, a switch, a mouse, trackpad, touch screen, etc. Output component 250 may include a mechanism that outputs information to the operator, such as a display, a speaker, one or more light emitting diodes (LEDs), etc. Communication interface 260 may include any transceiver-like mechanism that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.) or a combination of wireless and wired communications. For example, communication interface 260 may include mechanisms for communicating with another device or system via a network, such as network 150.

As will be described in detail below, device 200 may perform operations relating to provisioning a feedback service in connection with a business, a product and/or service offered by such business, etc. Device 200 may perform these operations in response to processor 220 executing software instructions contained in a computer-readable medium, such as memory 230. A computer-readable medium may be defined as a non-transitory memory device. A memory device may include space within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of or in combination with software instructions to implement processes described herein. Thus, implementations described herein are not limited to any specific combination of hardware circuitry and software.

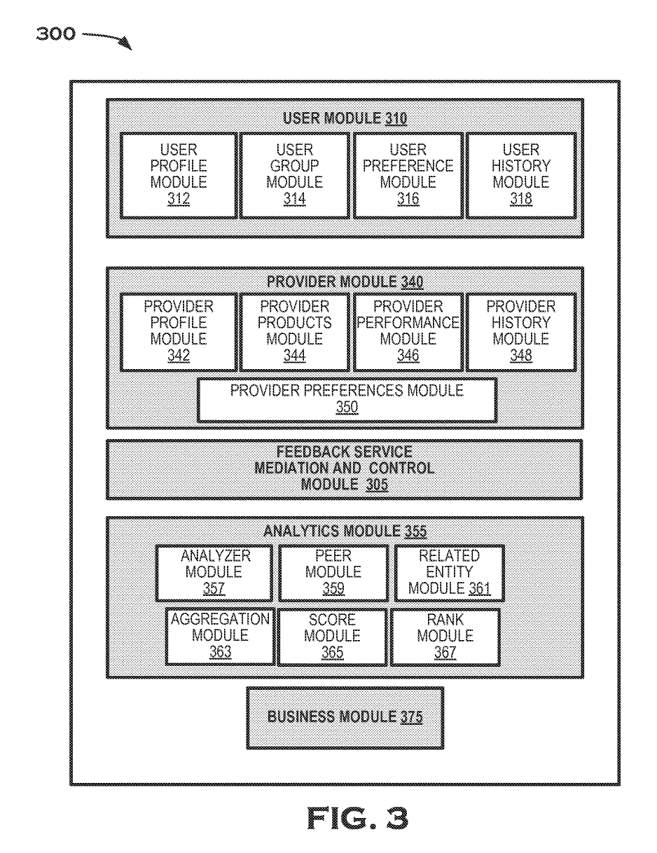

FIG. 3 is a diagram of an example framework 300 that may be associated with a feedback application being hosted and/or executed on application server 140, user device 110 and/or provider server 120. Additionally, or alternatively, the feedback application may be hosted and/or executed on application server 140, user device 110 and/or any of provider servers 120. Framework 300 may include logic in the form of software, hardware (e.g., electronic, optical, etc.) or a combination of software and hardware that, when executed, enables application server 140, user device 110 and/or provider server 120 to perform the functions, activities, or tasks described herein. As shown in FIG. 3, framework 300 may include a feedback and mediation control module 305 (hereafter, “control module 305”), a user module 310, a provider module 340, an analytics module 355, and a business module 375.

Control module 305 may control a manner in which application server 140 uses modules 310-375. User module 310 may enable feedback services to be provided to a user of user device 110. User module 310 may, for example, include a user profile module 312, a user group module 314, a user preferences module 316, and a user history module 318. User profile module 312 may enable application server 140 to create and/or maintain a profile associated with a user and/or user device 110 from which feedback, associated with a provider, may be received. Such a user profile may include user information (e.g., a name of user, an address of the user, a user email address, etc.), information associated with user device 110 (e.g., a network address, Internet Protocol (IP) address, a mobile directory number, an electronic serial number, etc.), an account number, a type of user subscription, etc.

User group module 314 may enable application server 140 to manage and/or track a user group of which one or more users are members and to which one or more user devices 110 are associated. User group module 314 may enable application server 140 and/or user device 110 to create a user group based a common interest shared by one or more users. Such a user group may, for example, be associated with a particular provider, industry, product, service, etc. User preferences module 316 may enable preferences, associated with a user of user device 110, to be identified and/or managed. The preferences may, for example, identify a product, service, provider, industry, etc. preferred by the user, which may cause application server 140 and/or provider server 120, associated with a preferred provider, to provide promotional material, surveys, or other material to user device 110, based on the user preferences. User history module 318 may enable application server 140 to manage and/or track prior feedback, ratings, surveys, or other communications provided by user device 110 based on user experiences, opinions, or impressions of a provider, a product, a service, etc.

Provider module 340 may enable feedback services to be provided to a provider associated with provider server 120. Provider module 340 may, for example include a provider profile module 342, a provider products module 344, a provider performance module 346, a provider history module 348, and a provider preferences module 350. Provider profile module 342 may enable application server 140 to create and/or maintain a profile associated with a provider and/or provider server 120 to which feedback, associated with the provider, may be provided by application server 140. Such a provider profile may include provider information (e.g., a name of a provider, an address of the provider, a provider email address, etc.), information associated with provider server 120 (e.g., a network address, Internet Protocol (IP) address, a media access control (MAC) address, etc.), an account number, a type of provider subscription, etc.

Provider products module 344 may enable information that identifies and/or describes a product, service, or information offered by the provider to be tracked and/or managed over time. Provider performance module 346 may enable application server 140 to monitor and/or track the performance of a provider based on feedback received from one or more user devices 110 based on a measure of sentiment obtained from the feedback, ratings provided by user of user devices 110, scores assigned to the provider and/or a product, service and/or information offered by the provider by application server 140 based on the feedback. Provider history module 348 may enable application server 140 to monitor and/or track feedback associated with the provider received from one or more user devices 110 over a period of time. Provider preferences module 350 may enable preferences, of a provider, to be managed and/or stored. The provider preferences may, for example, identify one or more other providers that are subsidiaries, branches, parent companies and/or otherwise associated with the provider for purposes of aggregating and/or processing feedback associated with such other providers. Additionally, or alternatively, the provider preferences may identify one or more other providers that are peers of the provider and against which feedback, analytics and/or other information may be compared to enable the provider to assess performance of the provider and/or a product or service of the provider relative to a peer provider, and/or a product or service of the peer provider.

Analytics module 355 may enable application server 140 to process feedback information, aggregate feedback, and/or create feedback analytics. Analytics module 355 may, for example, include an analyzer module 357, a peer module 359, a related entity module 361, an aggregation module 363, a score module 365, and a rank module 367. Analyzer module 357 may enable application server 140 to process feedback by identifying certain keywords associated with a product and/or service that enables an opinion or sentiment, of a user of user device 110, to be determined as a result of a user experience regarding the product or service. Analyzer module 357 may also, or alternatively, enable application server 140 to assign a score to feedback based on the keywords (e.g., positive keywords, negative keywords, neutral keywords, etc.) and/or ratings (e.g., based on a quantity of stars, a number rating, a thumbs up or thumbs down, etc.) provided by a user of user device 110.

Peer module 359 may enable application server 140 to identify an industry peer provider with which feedback and/or performance, of the provider, is compared to provide feedback analytics to provider server 120 associated with the provider. The industry peer provider may be identified by the provider preferences (e.g., associated with provider preferences module 350) and/or may be automatically identified by application server 140. An industry peer provider may include, for example, a provider that provides a similar product and/or service as the provider, a provider in a same, similar, or related industry as the provider, a provider in a same, similar, or related geographic location as the provider, a provider with a similar customer base as the provider, etc. Related entity module 361 may identify one or more providers, associated with other provider servers 120, that are branches, subsidiaries and/or parent entities associated with the provider, which are identified by the provider and/or one or more of the other providers.

Aggregation module 363 may enable application server 140 to provide, to provider server 120, to combine feedback based on feedback provided by two or more users of user devices 110 to create aggregate feedback. Application server 140 may, for example, aggregate feedback associated with one or more industry peers and may provide such aggregate feedback to provider server 120 to enable the performance of the provider, associated with provider server 120, to be determined relative to the performance of the industry peers. Application server 140 may also, or alternatively, aggregate feedback associated with provider servers 120 associated with one or more related entities and may provide the aggregate feedback to provider server 120 to enable the performance of the provider to be determined relative to one or more related entities. Score module 365 may enable application server 140 to create, compute and/or otherwise obtain a score associated with feedback received from user device 110 and may assign the score to such feedback. The score may be based on a quantity of keywords within the feedback that match stored keywords (e.g., stored in database 145 or some other memory), a sentiment associated with the feedback, a rating associated with the feedback, etc. Rank module 367 may enable application server 140 to rank feedback, associated with a provider, with other feedback associated with the provider and/or other providers based on a score associated with the feedback relative to one or more other scores associated with the other feedback.

Business module 375 may enable application server 140 to manage and/or control an account or perform billing associated with a user of user device 110 and/or a provider associated with provider server 120.

Although FIG. 3 shows an example number of modules associated with framework 300, in other implementations, framework 300 may include fewer modules, additional modules, different modules, or differently arranged modules than depicted in FIG. 3. In still other implementations, one or more modules of framework 300 may perform one or more tasks, functions and/or operations described as being performed by one or more other modules of framework 300.

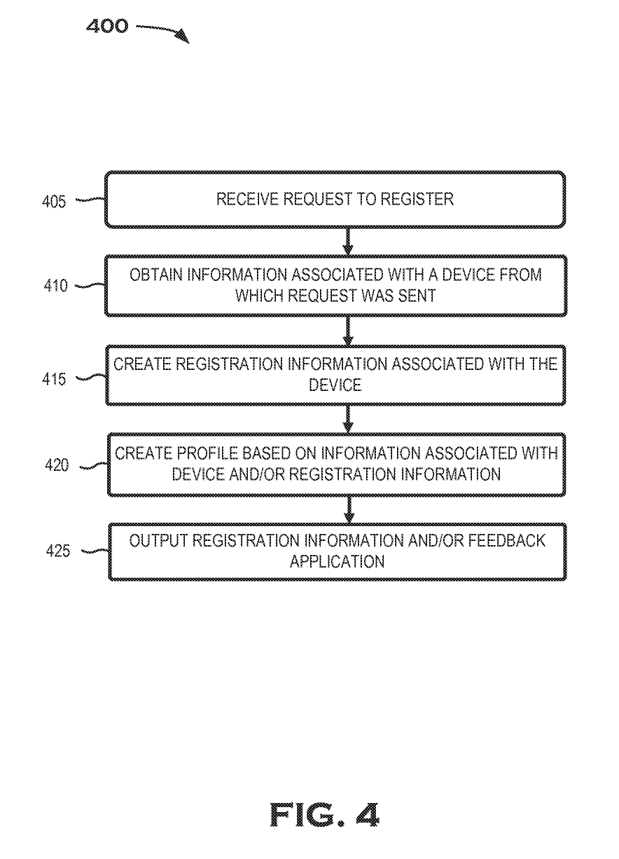

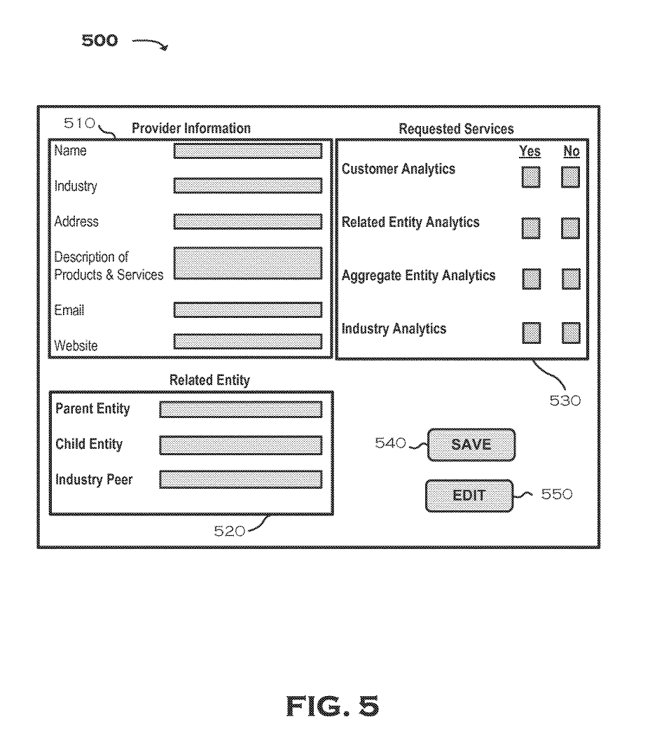

FIG. 4 is a flow chart of an example process 400 that may be used to register one or more devices of FIG. 1 according to an implementation described herein. Process 400 may be performed by application server 140. Additionally, or alternatively, some or all of process 400 may be performed by a device or a collection of devices separate from, or in combination with, application server 140. FIG. 5 is a diagram of an example user interface 500 that may be used to set up or register provider server 120 associated with a provider identified in FIG. 1. Some or all of process 400 of FIG. 4 is described below with references to user interface 500 of FIG. 5.

As shown in FIG. 4, process 400 may include receiving a request to register (BLOCK 405) and obtaining information associated with a device from which the request is sent (BLOCK 410). For example, user, associated with user device 110, may desire to provide feedback to one or more providers and may cause user device 110 to transmit a request to register with application server 140. User device 110 may also, or alternatively, provide information associated with the user (e.g., user name, address, email address, etc.) and/or user device 110 (e.g., an IP address, a mobile directory number, an electronic serial number (ESN), etc.) to application server 140.

Additionally, or alternatively, in a manner similar to that described in the immediately preceding paragraph, a provider may desire to receive feedback from user device 110 and/or feedback analytics and may cause provider server 120 to transmit a request to register with application server 140. Similarly, provider server 120 may also, or alternatively, provide information associated with the provider (e.g., a provider name, address, URL, etc.) and/or information associated with provider server 120 (e.g., an ESN, a media access control (MAC) address, an IP address, etc.) to application server 140. In a non-limiting example, application server 140 may receive the request and may provide information, to provider server 120 that enables a user interface to be displayed on provider server 120, such as user interface 500 of FIG. 5, via which the provider may enter preferences associated with a provider.

As shown in FIG. 5, user interface 500 may include a provider information field 510, a related entities field 520, a requested services field 530, a save button 540 and an edit button 550. Provider information field 510 may, for example, include a name field via which the provider may enter a name of the provider; an industry field via which the provider may identify an industry (e.g., fast food industry, consumer products industry, automobile industry, hospitality industry, etc.) in which the provider operates, an address field via which the provider may enter an address of the provider, and/or a description field via which the provider may enter a description of a product or service offered or sold by provider. Provider field 510 may include an email field via which the provider may enter an email address of a person that is employed by, or associated with, the provider, and/or a website field via which the provider may enter a network address (e.g., a URL, etc.) associated with a provider website.

Related entity field 520 may include a parent entity field via which a provider may enter a name of another provider that owns or controls all or a portion of the provider, a child entity field via which the provider may enter a name of a different provider, all or some of which is owned or controlled by provider, and/or an industry peer provider that offers products in a same or similar industry than the provider.

Requested services field 530 may include a customer analytics field that, if selected (e.g., by checking the “Yes” box), causes application server 140 to process feedback (received from one or more user devices 110 over a time period) to create analytics, in connection with feedback associated with the provider, and to provider the analytics to provider server 120. Requested services field 530 may also, or alternatively, include a related entity analytics field that, if selected (e.g., by checking the “Yes” box), causes application server 140 to process feedback (received from one or more user devices 110 over a time period) associated with the provider and/or a parent or child entity (identified in related entity field 520) to create related entity analytics. Application server 140 may transmit the related analytics to provider server 120. Requested services field 530 may also, or alternatively, include an industry analytics field that, if selected (e.g., by checking the “Yes” box), causes application server 140 to process feedback (received from one or more user devices 110 over a time period) associated with the provider and/or a peer provider (identified in related entity field 520) to create industry analytics. Application server 140 may transmit the industry analytics to provider server 120. If any of the fields, described above, are not selected (e.g., by checking the “No” box), then application server 140 may not create or provide, to provider server 120, the type of analytics that are not selected.

Save button 540, when selected by a provider, may cause provider server 120 to save as provider preferences (e.g., in a memory associated with provider server 120), the information entered into user interface 500 and/or may transmit the provider preferences to application server 140. Edit button 550 may enable the provider to change information entered and/or saved via user interface 500 and may save and/or transmit the edited preferences to application server 140.

The number of fields and/or buttons shown in FIG. 5, with respect to user interface 500, is provided for explanatory purposes only. Additionally, or alternatively, user interface 500 of FIG. 5 may include additional fields and/or buttons, fewer fields and/or buttons, different fields and/or buttons, or differently arranged fields and/or buttons than are shown in FIG. 5.

Application server 140 may receive the request to register and may obtain, from the request, information associated with the device (e.g., depending on from which of provider server 120 or user device 110 the request was sent) and/or the preferences.

As also shown in FIG. 4, process 400 may include creating registration information associated with the device (BLOCK 415), creating a profile based on the information associated with the device and/or the type of subscriber (BLOCK 420), and outputting the registration information to the device (BLOCK 425). For example, application server 140 may create registration information associated with user device 110 and/or the user (e.g., user name, password, personal identification number (PIN), a confirmation number, etc.). Additionally, or alternatively, application server 140 may create a user profile, associated with user device 110 and/or the user, that includes the registration information, the information associated with user device 110, the information associated with the user, etc. Application server 140 may store the user profile in database 145.

Additionally, or alternatively, application server 140 may create registration information associated with provider server 120 and/or the provider (e.g., provider name, password, provider identification (PID), a confirmation number, etc.). Additionally, or alternatively, application server 140 may create a provider profile, associated with provider server 120 and/or the provider, that includes the registration information, preferences, the information associated with provider server 120, the information associated with the provider, etc.). Application server 140 may store the provider profile in database 145.

Based on creating the user profile, application server 140 may transmit a notification (e.g., email, SMS message, text message, etc.), to user device 110, indicating that user device 110 and/or the user are registered. The notification may also, or alternatively, include the registration information that user device 110 may use to access application server 140 in a future session. Additionally, or alternatively, based on creating the provider profile, application server 140 may transmit a notification, to provider server 120, indicating that provider server 120 and/or the provider are registered. The notification may also, or alternatively, include the registration information that provider server 120 may use to access application server 140 in a future session.

Once registered, application server 140 may transmit a copy of a feedback application to user device 110 to enable user device 110 to store and/or install the feedback application on user device 110 for execution and use by the user to provide feedback. Additionally, or alternatively, user device 110 may obtain a copy of the feedback application from public server 130 that enables such application to be downloaded and/or purchased. In this example, public server 130 may act as an electronic store (e.g., such as the Google Store®, Apple® App Store®, etc.) from which copies of the feedback application and/or other applications may be obtained and/or downloaded. Additionally, or alternatively, application server 140 (and/or public server 130 as the electronic store) may transmit a different copy of a feedback application to provider server 120 to enable provider server 120 to store and/or install the different copy of the feedback application on provider server 120 for execution and use by the provider to receive feedback and/or analytics.

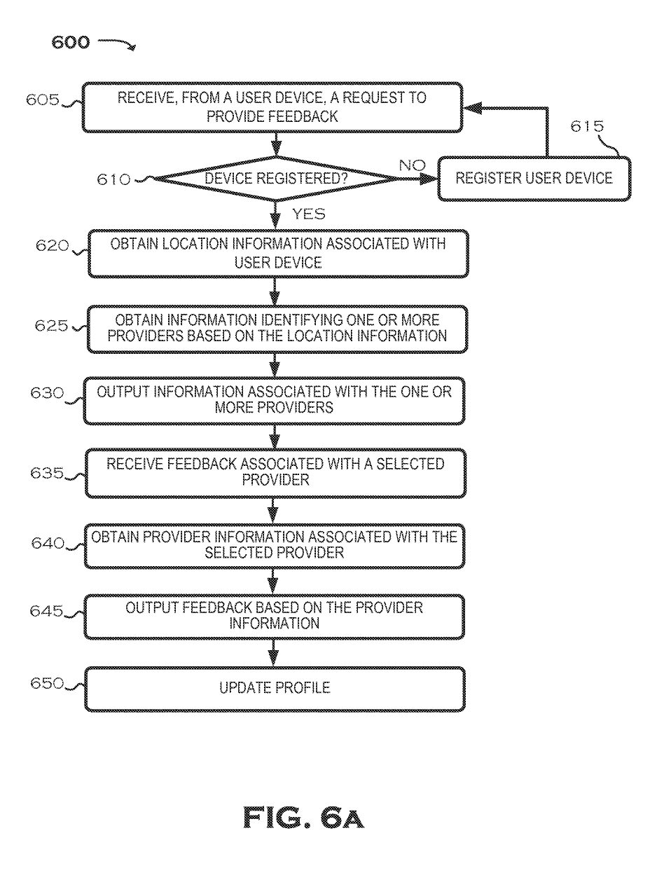

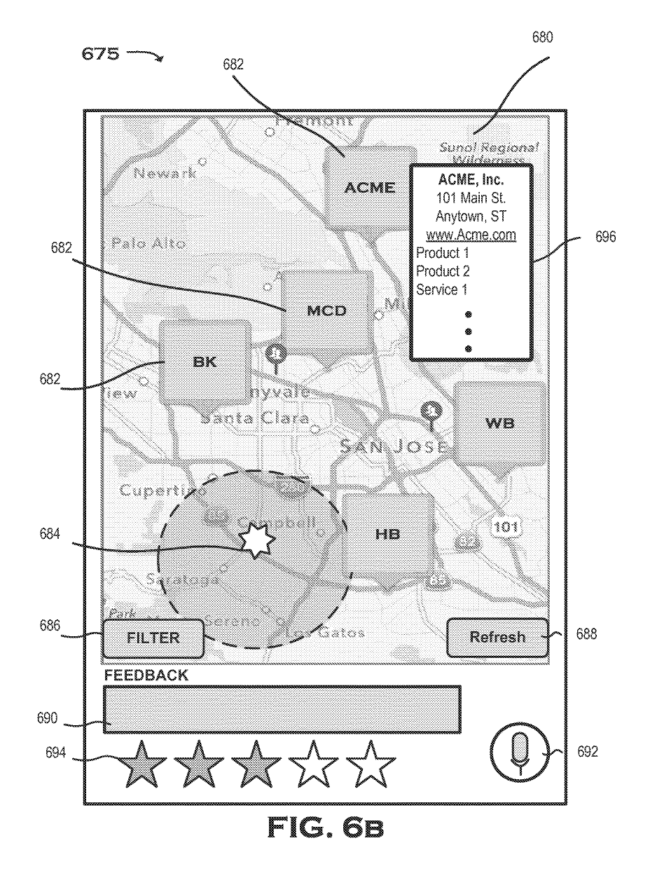

FIG. 6A is a flow chart of an example process 600 that may be used, by user device 110, to provide feedback to provider server 120 according to an implementation described herein. Process 600 may be used by user device 110. Additionally, or alternatively, some or all of process 600 may be performed by a device or a collection of devices separate from, or in combination with, user device 110. FIG. 6B is a diagram of an example user interface 675 that may be displayed on user device 110 and/or used to provide feedback to a selected provider associated with provider server 120. Process 600 of FIG. 6A will be described below with references to some or all of user interface 675 of FIG. 6B.

As shown in FIG. 6A, process 600 may include receiving, from a user device, a request to provide feedback (BLOCK 605), and if the device is not registered (BLOCK 610-NO), then process 600 may include registering the user device (BLOCK 615). For example, a user of user device 110 may desire to provide feedback to a provider and may open a feedback application on user device 110. The feedback application may cause user device 110 to transmit a request, to provide feedback, to application server 140. Application server 140 may receive the request and may obtain, from the request, information associated with user device 110 (e.g., an ESN, an MDN, an IP address, etc.), information associated with the feedback application (e.g., a unique application identifier, an APN, etc.), and/or information associated with the user (e.g., a user name, a PIN, a password, etc.). Application server 140 may determine whether the information, obtained from the request, matches information (e.g., registration information) stored in a memory (e.g., database 145). In the event that the obtained information does not match the stored information, application server 140 may, in a manner similar to that described above with respect to FIG. 4, communicate with user device 110 to register user device 110 and/or the user to enable the user to provide feedback to the provider.

Additionally, or alternatively, the user may encounter an identifier and/or code (e.g., a bar code, a quick response (QR) code, etc.) associated with a provider, such as, for example, on a menu, in an advertisement, newspaper, etc. The user may use user device 110 to scan the code and may provide the scanned code to application server 140.

As also shown in FIG. 6A, if the device is registered (BLOCK 610-YES), then process 600 may include obtaining location information associated with the user device (BLOCK 620). For example, in the event that the information, obtained from the request, matches the information stored in the memory (e.g., database 145, etc.), application server 140 may obtain information that identifies a location (e.g., latitude and/or longitude coordinates, coordinates on a geographical map, a zip code, a geographic area, a location on a highway or road, a cell identifier, a base station identifier, etc.) of user device 110 (hereinafter, “location information”). In one example, application server 140 may interrogate user device 110 to obtain the location information by, for example, sending a request for the location information to user device 110. In this example, user device 110 may receive the request and may use the feedback application to obtain the location information (e.g., GPS coordinates or information from user device 110 etc.) and/or to transmit the location information to application 140. Additionally, or alternatively, application server 140 may obtain the location information from public server 130 that provides a location service from which location information, associated with user device 110 and/or one or more other user devices 110, can be obtained. Additionally, or alternatively, user device 110 may obtain the location information from public server 130 and may transmit the location information to application server 140.

Additionally, or alternatively, application server 140 may process an identifier and/or a code (e.g., bar code, QR code, etc.), obtained from user device 110, to obtain a URL associated with a provider website via which the user may provide feedback in a manner described herein.

As further shown in FIG. 6A, process 600 may include obtaining information associated with one or more providers based on the location information (BLOCK 625) and outputting the information associated with one or more providers (BLOCK 630). Additionally, or alternatively, application server 140 may obtain information associated with one or more providers and/or provider servers 120 that are located within a geographic area a proximity thereto (e.g., within a zip code, metropolitan area, a county, a certain distance, radius, etc.) associated with a location of user device 110. In one non-limiting example, application server 140 may access information associated with providers and/or provider servers 120 that is stored within database 145, to identify one or more providers and/or provider servers 120 that are located within the geographic area, and may obtain information associated with the one or more providers and/or provider servers 120.

Additionally, or alternatively, application server 140 may communicate with public server 130, from which information associated with providers and/or provider servers 120 is publically available, to obtain information associated with one or more providers and/or provider servers 120, located within the geographic area, which are not registered with application server 140. Additionally, or alternatively, application server 140 may obtain, from public server 130 and/or database 145, information associated with the geographic area (e.g., identifying a map, a satellite image, roads, terrain, land forms, etc. and/or providers, churches, schools, etc. within the geographical area).

The information associated with a provider may identify the provider (e.g., based on the provider name, address, location, an employee contact, etc.), a particular server device 120 associated with the provider (e.g., an ESN, etc.), a network address associated with the particular server device 120 (e.g., a URL, an email address of the employee contact, a MDN, an IP address, a MAC address, etc.), and an indication of whether the provider and/or particular provider server 120 is registered with application server 140. For registered providers and/or provider servers 120, the information associated with the provider may include a logo, brand name, icons, etc., that are associated with the provider. Application server 140 may output, to user device 110, the information associated with the geographic area and/or the information associated with one or more providers and/or provider servers 120 that are located with the geographic area associated with a location of user device 110.

As yet further shown in FIG. 6A, process 600 may include receiving feedback associated with a selected provider (BLOCK 635) and obtaining provider information associated with the selected provider (BLOCK 640). For example, user device 110 may display information associated with one or more providers within a geographic area associated with the location of user device 110 and may transmit, to application server 140, feedback associated with a selected provider and/or user device 110. By way of a non-limiting example, user device 110 may display a user interface that identifies the geographic area and/or one or more providers within such geographic area, such as, for example, user interface 675 of FIG. 6B.

As illustrated in FIG. 6B, user interface 675 may include a collection of fields, objects and/or buttons such as a map field 680, a group of one or more provider icon objects 682 (hereinafter, collectively referred to as “icons 682” and individually as “icon 682”), a user location object 684 (hereinafter, “location 684”), a filter button 686, a refresh button 688, a feedback field 690, a feedback button 692, a rating buttons 694 and a popup window 696. The number of fields, objects and/or buttons shown in FIG. 6B, with respect to user interface 675, is provided for explanatory purposes only. Additionally, or alternatively, user interface 675 of FIG. 56B may include additional fields, objects and/or buttons; fewer fields, objects and/or buttons; different fields, objects and/or buttons; or differently arranged fields, objects and/or buttons than are shown in FIG. 6B.

Map field 680 may identify a map, a satellite image, one or more road, terrain, land forms, cities, towns, landmarks, etc. associated with the geographical area in which the user and/or user device 110 is located. Icon 682 may identify a name, symbol, shape, logo, brand name, etc. associated with a provider and/or provider server 120 that is associated with a first position, within map field 680, that corresponds to a first location of the provider and/or provider server 120 within the geographical area. The user may select a particular icon 682 associated with a provider to which the user desire to leave feedback. Selection of particular icon 682 may cause user device 110 to display provider information within user interface 675 (e.g., in a popup window 696, etc.) and/or a new user interface (not shown) that identifies the name of the provider, a URL of the provider website, an logo of the provider, a list of products or services, an address of the provider, etc.

Location 684 may identify a name, symbol, shape, logo, etc. associated with a user and/or user device 110 that is associated with a second position, within map field 680 that corresponds to a second location of the user and/or user device 110 within the geographical area. Filter button 686 may, when selected by the user of user device 110, enable the user to change a manner in which providers and/or provider servers 120 are displayed within user interface 675 such as, for example, by changing a scale of map 680, identifying a type of provider (e.g., restaurants, auto mechanics, coffee shops, car dealerships, florists, libraries, churches, etc.), changing a type of map (e.g., a satellite image, with or without terrain, birds eye or perspective, etc.), etc.

Refresh button 688 may, if selected by the user of user device 110, cause user device 110 to obtain, from application server 140, updated geographical information and/or location information (e.g., particularly if user device 110 has change location). Additionally, or alternatively, application server 140 may automatically cause user interface 675 to update (e.g., every 10 seconds, 30 seconds, 1 minute, 2 minutes, five minutes, etc.).

Feedback field 690 may allow the user to enter feedback (e.g., textual feedback) associated with a provider with which a selected icon 682 is associated and/or a facility, product, or service with which the provider is associated. Feedback button 692 may, when selected by the user, enable a user to provide spoken feedback to the provider with which selected icon 682 is associated. Rating buttons 694 may, when selected by the user, enable the user to assign a rating (e.g., 1 out of 5 stars (very poor rating), 2 out of 5 starts (poor rating), 3 out of five starts (fair rating), 4 out of 5 stars (good rating), or 5 out of 5 starts (very good rating), etc.) to the selected provider and/or a provider facility, product or service. Popup window 696 may identify a name of the selected provider (e.g., shown as Acme, Inc.), an address of the selected provider (e.g., 101 Main St., etc.), a URL of the selected provider website (e.g., shown as www.acme.com), and/or a product or service (e.g., shown as product 1, product 2, service 1, etc.). The user may select (e.g., using a pointing device, by touching a screen, by pressing one or more buttons on the keyboard, etc.) the provider name, a product or a service for which feedback is to be provided.

Returning to FIG. 6A, the user may view user interface 675 and may select a particular icon 682 associated with a provider to which the user desires to provide feedback. Additionally, or alternatively, user device 110 may obtain provider information associated with the selected provider and may present such provider information for display (e.g., via popup window 696 of FIG. 6B). The user may select, from the provider information, the provider name, a product, or a service for which feedback is to be provided. The user may enter written feedback (e.g., via feedback field 690), spoken feedback (e.g., by selecting feedback button 692 and speaking the feedback into user device 110), and/or a rating (e.g., by selecting between one or more stars in rating button(s) 694) associated with the provider, the product and/or the service. User device 110 may receive the feedback associated with the selected provider and may transmit the feedback to application server 140.

Application server 140 may receive the feedback information and may obtain, from the feedback, information identifying the selected provider. Application server 140 may also, or alternatively, obtain, from database 145, information that identifies provider server 120 associated with the selected provider (e.g., a URL, an IP address, a MAC address, an MDN, etc.).

As also shown in FIG. 6A, process 600 may include outputting feedback based on the provider information (BLOCK 645) and updating a profile (BLOCK 650). For example, application server 140 may use the information, associated with the identified provider server 120, to provide the feedback to provider server 120. The feedback may be transmitted in the form of an email message, a text message, audio content (e.g., a wave file, etc.), an HTTP message (e.g., a post message, etc.), etc.

Additionally, or alternatively, application server 140 may update a user profile associated with the user and/or user device 110 by storing, in the user profile within database 145, information associated with the feedback such as, for example, information that identifies a date and/or time when the feedback was sent from user device 110 and/or application server 140, a rating associated with the feedback, the textual or spoken feedback, the selected provider, provider server 120 (e.g., an ESN, a network address, etc.), processed feedback (e.g., a score associated with the feedback, etc.), the subject matter of the feedback (e.g., provider, product, service, etc.), etc.

Additionally, or alternatively, application server 140 may update a provider profile associated with the selected provider and/or provider server 120 by storing, in the provider profile within database 145, information associated with the feedback, such as, for example, information that identifies the date and/or time when the feedback was received from user device 110 and/or application server 140, the rating associated with the feedback, the textual or spoken feedback, the subject matter of the feedback (e.g., provider, product, service, etc.), user device 110 (e.g., an ESN, MDN, a network address, etc.), processed feedback (e.g., a score associated with the feedback, etc.), etc.

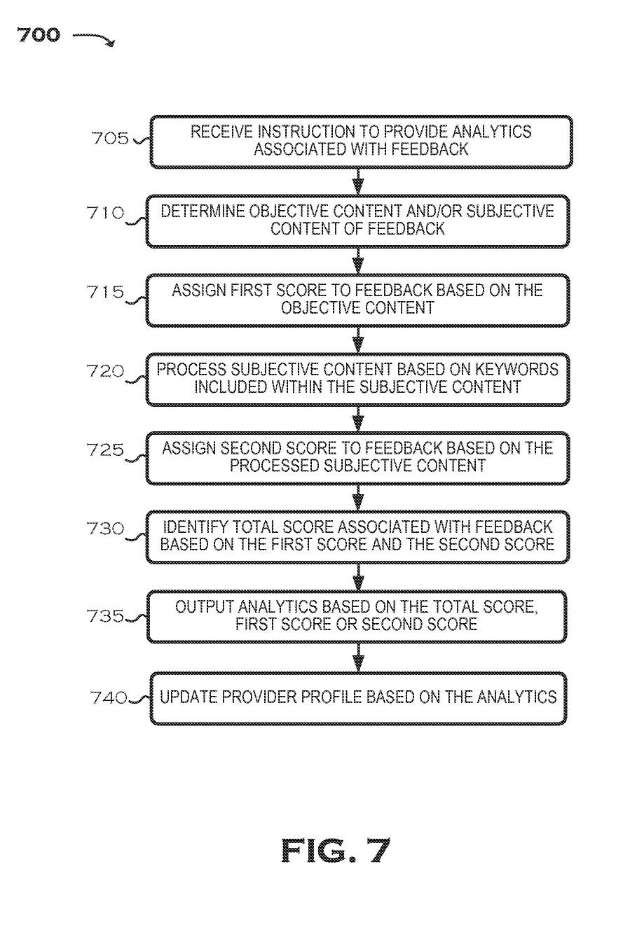

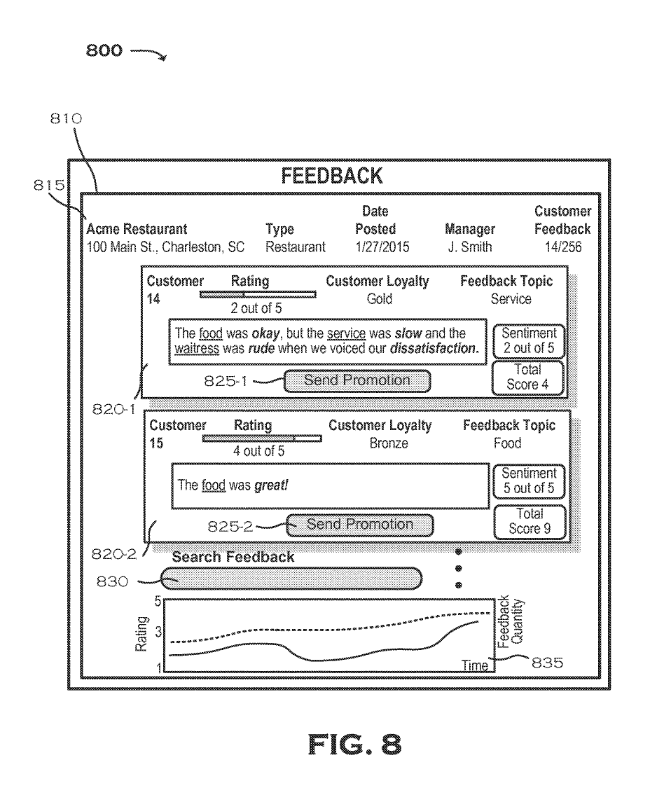

FIG. 7 is a flow chart of an example process 700 that may be used to process feedback received from a user device and/or to create analytics associated with a provider. Process 700 may be performed by application server 140. Additionally, or alternatively, some or all of process 700 may be performed by a device or a collection of devices separate from, or in combination with, application server 140. FIG. 8 is a diagram of an example user interface 800 via which information associated with feedback, received from one or more user devices, may be displayed. Process 700 of FIG. 7 will be described below with references to some or all of user interface 800 of FIG. 8.

As shown in FIG. 7, process 700 may include receiving an instruction to provide analytics associated with feedback (BLOCK 705) and determining objective content and/or subjective content of feedback (BLOCK 710). For example, application server 140 may receive feedback, from user device 110 and may identify, based on the feedback, to which provider and/or provider server 120 the feedback is to be provided. Based on the identification of the provider and/or user device 120, application server 140 may obtain, from database 145, a profile associated with the identified provider and/or provider server 120 and may determine, based on the provider profile, whether the provider preferences (such as those entered by provider into requested services field 530 of FIG. 5) indicate that feedback analytics are to be provided to provider server 120. In the event that the provider profile indicates that analytics are not to be provided to provider server 120, application server 140 may not create feedback analytics. However, in the event that the provider profile indicates that analytics are to be provided to provider server 120, application server 140 (e.g., using analytics module 355) may process the feedback to identify objective content and/or subjective content included within the feedback. The objective content may, for example, include any rating (e.g., based on a star rating, a quantitative or numerical rating, a thumbs up and/or thumbs down rating, etc.) that corresponds to a quantified rating or (e.g., S1) score associated with the provider, and/or a product and/or service offered by the provider. The subjective content may correspond to written and/or textual feedback, audio and/or spoken feedback, and/or video feedback provided by a user of user device 110.

As also shown in FIG. 7, process 700 may include assigning a first score to the feedback based on the objective content (BLOCK 715) and processing the subjective content based on keywords included within the subjective content (BLOCK 720). For example, application server 140 (e.g., using analytics module 355) may assign a first score to the feedback based on a rating, provided by a user of user device 110, included within the objective content. In a non-limiting example, the first score may correspond to a first value when the rating is a high rating (e.g., 4 or 5 stars out of 5 stars, etc.). In one example, the first value may match the rating (e.g., S1≈ to 4 when the rating is 4 out of 5 stars, S1≈5 when the rating is 5 out of 5 stars, respectively, etc.). In another non-limiting example, the first score may correspond to a second value that is less than the first value when the rating is a medium rating that is lower than the high rating (e.g., 3 out of 5 stars, etc.). In one example, the first value may match the rating (e.g., S1≈ to 3 when the rating is 3 out of 5 stars). In yet another non-limiting example, the first score may correspond to a third value that is less than the second value when the rating is a low rating that is lower than the medium rating (e.g., 1 or 2 stars out of 5 stars, etc.). In one example, the third value may match the rating (e.g., S1≈ to 1 when the rating is 1 out of 5 stars, S1≈ to 2 when the rating is 2 out of 5 stars, etc.).

Additionally, or alternatively, application server 140 (e.g., using analytics module 355) may process the subjective content to identify any keywords, associated with the subjective content, that match keywords stored within database 145. In a non-limiting example, application server 140 may determine that a first keyword matches a first keyword previously stored in database 145 that is associated with positive sentiment. Such first keywords, associated with positive sentiment may correspond to descriptive terms associated with positive, favorable, desirable and/or satisfactory impressions, experiences, or opinions of the other users, of user devices 110, in connection with providers, and/or products and/or services offered by such providers. Additionally, or alternatively, application server 140 may determine that a second keyword matches a second keyword previously stored in database 145 that is associated with negative sentiment. Such second keywords, associated with negative sentiment may correspond to descriptive terms associated with negative, unfavorable, undesirable and/or unsatisfactory impressions, experiences, or opinions of other users, of user devices 110, in connection with the providers, and/or products and/or services offered by such providers. Application server 140 may determine a quantity of first keywords, associated with the feedback, that match the previously stored first keywords and/or may determine a quantity of second keywords, associated with the feedback, that match the previously stored second keywords.

As further shown in FIG. 7, process 700 may include assigning a second score to the feedback based on the processed subjective content (BLOCK 725) and identifying a total score, associated with the feedback based on the first score and the second score (BLOCK 730). For example, based on the quantity of matching first keywords or second keywords, application server 140 may assign a second score (e.g., S2) to the feedback. In a non-limiting example, when the quantity of first keywords are greater than the quantity of second keywords, application server 140 may assign a second score that corresponds to a high second score (e.g., S2≈4, 5, etc. out of 5, S2≈7, 8, 9, 10, etc. out of 10, etc.). Additionally, or alternatively, when the quantity of first keywords are approximately equal to the quantity of second keywords, application server 140 may assign a second score that corresponds to a medium second score (e.g., S2≈3 out of 5, S2≈4, 5, 6, etc. out of 10, etc.). Additionally, or alternatively, when the quantity of first keywords are less than the quantity of second keywords, application server 140 may assign a second score that corresponds to a low second score (e.g., S2≈1, 2, etc. out of 5, S2≈1, 2, 3, etc. out of 10, etc.).

Additionally, or alternatively, application server 140 may identify a total score associated with the feedback (e.g., ST), based on a combination of the first score and the second score (e.g., ST=S1+S2). Additionally, application server 140 may determine a weighted total score based on a weighted combination of the first score and the second score (e.g., STW=W1*S1+W2*S2, where W1+W2=1 and where 0≦W1≦1 and 0≦W2≦1). In this non-limiting example, the weighted total score may be based on weighting factors (e.g., W1, W2, etc.) that control how much the first score contributes to the total score (e.g., W1*S1) relative to the contribution of the second score (e.g., W2*S2), such that when the first score, associated with the objective content within the feedback, is to contribute more to the total score than the second score, associated with the subjective content within the feedback, the first weighting factor (e.g., W1) may be greater than the second weighting factor (e.g., W2) (e.g., where W1>W2). However, when the second score, associated with the subjective content within the feedback, is to contribute more to the total score than the first score, associated with the objective content within the feedback, the second weighting factor may be greater than the first weighting factor (e.g., where W2>W1). Additionally, or alternatively, when the second score, associated with the subjective content within the feedback, is to contribute equally to the total score as the first score, associated with the objective content within the feedback, the second weighting factor may be approximately equal to the first weighting factor (e.g., where W2≈W1). Application server 140 may associate the total score, the total weighted score, the first score and/or the second score to the feedback and may one or more such scores in database 145 in connection with the feedback.

As yet further shown in FIG. 7, process 700 may include outputting analytics based on the total score, first score, and/or second score (BLOCK 735) and updating a provider profile based on the analytics (BLOCK 740). For example, application server 140 may transmit the feedback to provider server 120 when provider server 120 and/or the provider is registered with application server 140. Additionally, or alternatively, application server 140 may transmit, to provider server 120, the total score, the total weighted score, the first score, and/or the second score. Transmission of such feedback and/or the scores may enable provider server 120 to display such feedback on a display device associated with provider server 120 such as that illustrated in user interface 800 of FIG. 8.

As illustrated in FIG. 8, user interface 800 may include a collection of fields and/or buttons such as a feedback field 810, a provider field 815, a collection of analytics fields 820-1, 820-2, etc. (hereinafter referred to collectively as “analytics fields 820” and individually as “analytics field 820”), a collection of promotion buttons 825-1, 825-2, etc. (hereinafter referred to collectively as “promotion buttons 825” and individually as “promotion button 825”), a search field 830 and a trends field 835. The number of fields and/or buttons shown in FIG. 8, with respect to user interface 800, is provided for explanatory purposes only. Additionally, or alternatively, user interface 800 of FIG. 8 may include additional fields and/or buttons; fewer fields and/or buttons; different fields and/or buttons; or differently arranged fields and/or buttons than are shown in FIG. 8.

Feedback field 810 may include information associated with feedback, associated with a provider and/or provider server 120, provided by user device 110 and/or information that identifies analytics associated with such feedback created by application server 140. Provider field 815 may include information that identifies the particular provider such as the name of the particular provider (e.g., shown as Acme Restaurant), a type of provider (e.g., shown as Restaurant), a date the feedback was provided by user device 110 and/or received by provider server 120 (e.g., shown as Jan. 27, 2015), a name of an employee, manager and/or agent of the provider (e.g., shown as J. Smith), and/or an identifier associated with the feedback (e.g., shown as 14 out of 256). Additionally, or alternatively, feedback field 810 may include other fields that set forth the analytics associated with such feedback and/or other feedback previously sent to and/or received by provider server 120.

For example, analytics field 820 may include information associated with analytics created and/or computed by application server 140 such as a customer identifier (e.g., shown as 14, 15, etc.), an objective rating provided by the user of user device 110 (e.g., shown as 2 out of 5 for customer 14, 4 out of 5 for customer 15, etc.), a level of customer loyalty (e.g., shown as gold for customer 14, bronze for customer 15, etc.), and the subject matter to which the feedback is provided, such as a product, service, or the provider (e.g., shown as a service for customer 14, food for customer 15, etc.). The level of customer loyalty (e.g., gold, silver, bronze, etc., or some other indicator of level of loyalty) may be based on a quantity of time that the user, of user device 110, has provided feedback for the provider. The level of loyalty may be determined based on the quantity of times feedback has been provided by the user, to the provider and/or provider server 120, as identified in the user profile. If, for example, the quantity of times is greater than a threshold, then the loyalty level may correspond to a first loyalty level (e.g., a gold level); if less than the first threshold but greater than or equal to a second threshold, then the loyalty level may correspond to a second loyalty level (e.g., a silver level); and if the if less than the second threshold, then the loyalty level may correspond to a third loyalty level (e.g., a bronze level). The number of thresholds and/or loyalty levels shown in FIG. 8 is not intended to be limiting.

Additionally, or alternatively, analytics field 820 may include a field in which a feedback narrative is included. Such narrative may cause the appearance of first or second keywords (e.g., shown in bold print), identified by application server 140, to be distinguished from other words or terms within the narrative. Also, or alternatively, application server 140 may cause words and/or terms, associated with the subject matter of the feedback, to be distinguished in appearance from other words or keywords within the narrative (e.g., shown as underlined words). Analytics field 820 may also, or alternatively, identify a second score associated with the subjective content (e.g., shown as sentiment 2 out of 5, sentiment 5 out of 5, etc.) and/or a total score associated with the feedback based on a combination of the first score (e.g., based on the objective content, such as the rating) and the second score (e.g., based on the subjective content, such as the sentiment) (e.g., shown as total score 4, total score 9, etc.).

Promotion button 825, when selected by the provider, may enable the provider to transmit promotional material to user device 110 based on the feedback and/or analytics associated therewith. In one non-limiting example, the provider may select send promotion button 825-1 to cause application server 140 to provide a first promotional content to a user, of user device 110 associated with customer 14, based on the customer loyalty (e.g., gold) and/or the total score of 4 (e.g., or some other score). Additionally, or alternatively, the provider may select send promotion button 825-2 to cause application server 140 to provide a second promotional content to a different user, of a different user device 110 associated with customer 15, based on the customer loyalty (e.g., bronze) and/or the total score of 9 (e.g., or some other score). The promotional content may include advertising content about a particular product and/or service, a coupon, a discount, a survey, etc.

Search field 830 may enable the provider to enter a search term, which may cause application server 140 to search feedback previously received over a period of time to identify particular feedback that includes one or more terms that match the search term. Application server 140 may transmit, to provider server 120, the particular feedback and/or analytics associated therewith.

Trends field 835 may identify analytics in connection with previously received feedback associated with the provider, to identify trends associated with such feedback, such as, for example, a rating (e.g., as shown as the solid line in FIG. 8), an average rating (e.g., per day, per week, per month, etc.), a total score, an average total score (e.g., per day, per week, per month, etc.), etc. as a function of time. Trends field 835 may also, or alternatively, identify a quantity of feedback (e.g., as shown as the dashed line in FIG. 8) previously received as a function of time.

Returning now to FIG. 7, application server 140 may update a provider profile by storing information associated with the analytics in the provider profile within database 145. For example, application server 140 may store the first score, the second score, the total score, the objective content, the subjective content, one or more keywords, etc. associated with the feedback in a data structure associated with the provider profile.

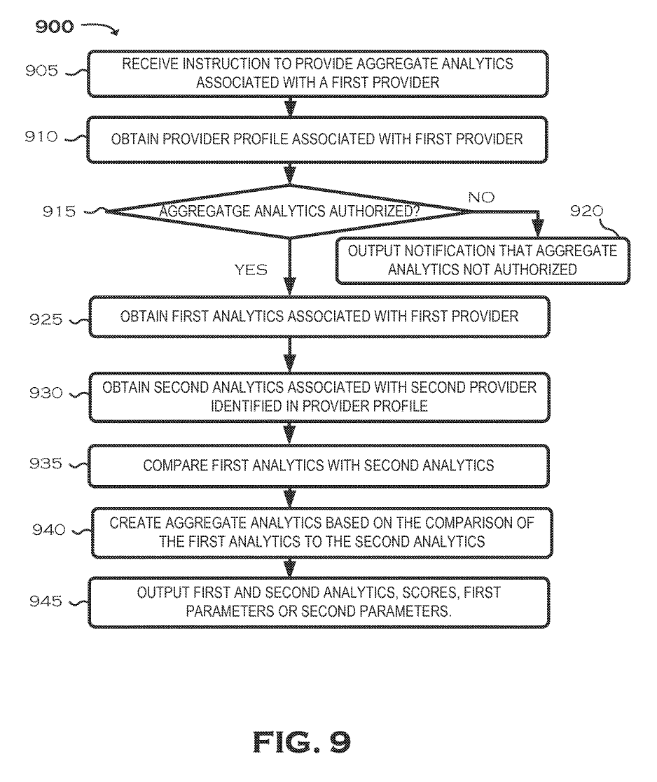

FIG. 9 is a flow chart of an example process 900 that may be used to create aggregate feedback associated with a provider. Process 900 may be performed by application server 140. Additionally, or alternatively, some or all of process 900 may be performed by a device or a collection of devices separate from, or in combination with, application server 140.

As shown in FIG. 9, process 900 may include receiving an instruction to create aggregate analytics associated with a first provider (BLOCK 905) and obtaining a profile associated with the first provider (BLOCK 910). For example, application server 140 may receive an instruction from first provider server 120, associated with a first provider, to provide first aggregate analytics associated with the first provider and/or a second provider associated with a second provider server 120. Application server 140 may obtain, from the instruction, information associated with first provider server 120 (e.g., an ESN, an IP address, a MAC address, etc.) and/or the first provider (e.g., a provider identifier, name, address, email address, etc.) and may use the information, associated with first provider server 120 and/or the first provider, to obtain a provider profile, associated with the first provider and/or first provider server 120, from database 120.

As also shown in FIG. 9, if aggregate analytics are not authorized (BLOCK 915-NO), process 900 may include out putting a notification that the aggregate analytics are not authorized (BLOCK 920). For example, application server 140 (e.g., using provider module 340 and/or provider profile 342) may determine whether the provider profile indicates that aggregate feedback and/or analytics is authorized and/or specified by the first provider. If the provider profile indicates that the aggregate feedback and/or analytics is not authorized or specified by the first provider, application server 140 may not create the aggregate feedback and/or analytics and/or may output a notification, to first provider server 120, that the aggregate feedback and/or analytics are not authorized. Alternatively, in the event that database 145 does not include a provider profile, then application server 140 may not create the aggregate feedback and/or analytics and/or may output a notification, to first provider server 120, to register with application server 140.

As further shown in FIG. 9, if aggregate analytics are authorized (BLOCK 915-YES), process 900 may include obtaining first analytics associated with the first provider (BLOCK 925) and obtaining second analytics associated with the second provider identified by the profile (BLOCK 930). For example, application server 140 (e.g., using provider module 340 and/or provider profile 342) may determine that the provider profile indicates that aggregate feedback and/or analytics is authorized and/or specified by the first provider. Based on the determination that the provider profile indicates that the aggregate feedback and/or analytics is authorized or specified by the first provider, application server 140 (e.g., using analytics module 355 and/or aggregation module 363) may obtain first feedback and/or first analytics associated with first provider server 120 and/or the first provider. For example, application server 140 may obtain, from database 145, first feedback previously received from one or more user devices 110 and may process the first feedback to create first analytics in a manner similar to that described above with respect to process 700 of FIG. 7. Additionally, or alternatively, application server 140 may obtain first analytics directly from database 145.

The first analytics may, for example, identify a quantity of feedback, directed to the first provider and/or first provider server 120, received from one or more user devices 110, users and/or user devices 110 from which the first feedback was transmitted (with consent of the users), one or more total scores assigned to the first feedback, one or more first scores (e.g., based on objective content, ratings, etc.) assigned to the first feedback, one or more second scores (e.g., based on subjective content, a sentiment rating, etc.) assigned to the first feedback, one or more levels of customer loyalty (e.g., bronze, silver, gold, or some other level), one or more products and/or services to which the first feedback is directed, one or more dates on which the first feedback was transmitted and/or received, ratings, scores and/or quantity of first feedback over a period of time, etc.

Additionally, or alternatively, application server 140 may obtain, from database 145, second feedback previously received from one or more user devices 110 that are directed to the second provider, associated with a second provider server 120, specified by the first provider in the provider profile. For example, application server 140 may process the second feedback to create second analytics in a manner similar to that described above with respect to process 700 of FIG. 7. Additionally, or alternatively, application server 140 may obtain second analytics directly from database 145.

The second analytics may, for example, identify a quantity of second feedback, directed to the second provider and/or second provider server 120, received from one or more user devices 110, users and/or user devices 110 from which the second feedback was transmitted (with consent of the users), one or more total scores assigned to the second feedback, one or more first scores (e.g., based on objective content, ratings, etc.) assigned to the second feedback, one or more second scores (e.g., based on subjective content, a sentiment rating, etc.) assigned to the second feedback, one or more levels of customer loyalty (e.g., bronze, silver, gold, or some other level), one or more products and/or services to which the second feedback is directed, one or more dates on which the second feedback was transmitted and/or received, ratings, scores and/or quantity of second feedback over a period of time, etc.

In a non-limiting example, the second provider may correspond to a child entity of the first provider (e.g., a partially or wholly owned or controlled subsidiary, branch, etc.) or a parent entity of the first provider (e.g., an owner or partial owner or controller of the first provider). In another non-limiting example, the second provider may correspond to a peer business that is a provider, within the same, similar or different industry that is not owned or controlled by the first provider and/or does not own or control the first provider. In this case, for example, the second provider may be a peer business (e.g., competitor, a partner, an industry leader, etc.) of the first provider in a same, similar, or different industry than the provider.

As yet further shown in FIG. 9, process 900 may include comparing the first analytics with the second analytics (BLOCK 935) and creating aggregate analytics based on the comparison of the first analytics with the second analytics (BLOCK 940). For example, application server 140 (e.g., using analytics module 355 and/or aggregation module 363) may compare a first parameter associated with the first analytics (e.g., an average quantity of first feedback received), with a corresponding first parameter associated with the second analytics (e.g., an average quantity of second feedback received), to determine whether the first parameter, of the first analytics, is greater than, equal to, or less than the first parameter of the second analytics during a particular time period. Additionally, or alternatively, application server 140 may compare a second parameter associated with the first analytics (e.g., an average total score associated with the first feedback), with a corresponding second parameter associated with the second analytics (e.g., an average total score associated with the second feedback), to determine whether the second parameter, of the first analytics, is greater than, equal to, or less than the second parameter of the second analytics during the particular time period. Application server 140 may compare other parameters (e.g., instantaneous and/or average first scores, second scores, weighted scores, ratings, levels of loyalty, levels of sentiment, etc.), associated with the first analytics to those of the second analytics in a manner described above.

Based on the comparison of the first analytics and the second analytics, application server 140 may create aggregate analytics. The aggregate analytics may enable the first provider to identify which parameters, associated with the first feedback, are greater than those of the second feedback, associated with the second provider, which may indicate that the first provider and/or the first provider's product and/or service is outperforming that of the second provider.

Additionally, or alternatively, the aggregate analytics may enable application server 140 and/or the first provider to identify which parameters, associated with the first feedback, are approximately equal to those of the second feedback, associated with the second provider, which may indicate that the first provider, the first provider's product, and/or the service is outperforming that of the second provider. Additionally, or alternatively, the aggregate analytics may enable application server 140 and/or the first provider to identify which parameters, associated with the first feedback, are less than those of the second feedback, associated with the second provider, which may indicate that the first provider and/or the first provider's product and/or service is being outperformed by that of the second provider. Such aggregate analytics may enable the first provider to determine relative performance between the first provider and the second provider that is a peer business or entity (e.g., when the second provider and/or second provider server 120 are in the same, similar, or different industry as the first provider and/or first provider server 120).

Additionally, or alternatively, second analytics of two or more second providers, associated with two or more second provider servers 120, may be compared with each other in a manner similar to that described above to create aggregate analytics between the two or more second providers. Such second providers may, for example, be subsidiaries of the first provider. In this non-limiting example, the aggregate analytics may enable the first provider to determine the relative performance of one or more of the subsidiaries.

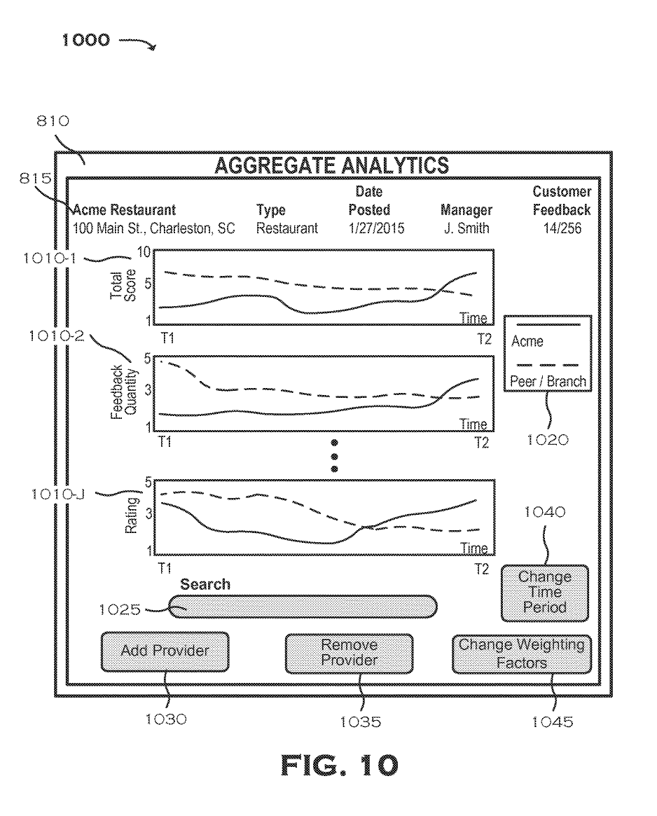

As further shown in FIG. 9, process 900 may include outputting the aggregate analytics (BLOCK 955). For example, application provider server 120 may output, as the aggregate analytics, the first analytics and the second analytics and the comparisons thereof. Such output may be transmitted, to provider server 120, for display on a display device associated with provider server 120 such as that illustrated in FIG. 10.

FIG. 10 includes an example user interface 1000 that may identify aggregate analytics between two or more providers. As illustrated in FIG. 10, user interface 1000 may include one or more buttons and/or fields, such as a group of analytics trends field 1010-1, . . . , 1010-J (where J≧1) (hereinafter, collectively referred to as “trends 1010” and individually as “trend 1010”), a legend field 1020, a search field 1025, an add provider button 1030, a remove provider button 1035, a change weighting factors button 1040 (hereinafter, “weighting factors button 1040”) and a change time period button 1045 (hereinafter, “time period button 1045”). The number of fields and/or buttons shown in FIG. 10, with respect to user interface 1000, is provided for explanatory purposes only. Additionally, or alternatively, user interface 1000 of FIG. 10 may include additional fields and/or buttons, fewer fields and/or buttons, different fields and/or buttons, or differently arranged fields and/or buttons than are shown in FIG. 10.

Trend 1010 field may identify a relationship (e.g., shown as a graph in FIG. 10, but need not be so limited) over a time period (e.g., shown as a horizontal time scale between a time period from t1 to t2 in FIG. 10) between a first parameter associated with first analytics that is based on first feedback directed to a first provider associated with first provider server 120 and a corresponding first parameter associated with second analytics that is based on second feedback directed to a second provider, associated with second provider server 120. The range of values of the first parameters may be shown in FIG. 10 on a vertical axis and scale. Such relationships may take the form of a graph depicting two or more points, curves, and/or surfaces that represent the relationship between values of the parameters associated with the first analytics and the time period relative to the second values of parameters associated with the second analytics and the time period.

For example, trend 1010-1 may identify a relationship, during the time period, between values representing a first total score (e.g., TS1), associated with first feedback, that are directed to the first provider associated with first provider server 120 and second values representing a second total score (e.g., TS2), associated with second feedback, that are directed to the second provider (associated with second provider server 120). Additionally, or alternatively, trend 1010-2 may identify a relationship, during the time period, between a quantity of first feedback directed to the first provider associated with first provider server 120 and a quantity of second feedback directed to the second provider, associated with second provider server 120. Trends 1010-3 through 10104 may identify relationships between other parameters within the first analytics (e.g., first scores, second scores, ratings, levels of sentiment, levels of customer loyalty, etc.) and corresponding other parameters included within second analytics.

Additionally, or alternatively, trends 1010 may identify relationships (not shown in FIG. 10) between parameters included within second analytics associated with a first subsidiary provider and a second subsidiary provider of the first provider.

Legend field 1020 may include a respective different symbol that is used to identify to which provider (e.g., first provider, two or more second providers, etc.) each of the parameters are associated.

Search field 1025 may enable a provider to enter a search term (e.g., keyword found in feedback, a term used to identify a product or service, a particular date during the time period, a term used to identify a provider, etc.). Entering such a search term may cause application server 140 to obtain, from database 145, feedback, analytics, parameters, or aggregated analytics that include one or more terms that match the search term and may transmit such feedback, analytics, parameters and/or aggregated analytics to provider server 120 for display via user interface 1000.

Add provider button 1030 may, when selected by the provider, cause a window and/or field to be displayed, via user interface 1000, that enables the provider to enter information identifying a particular provider and/or to select the particular provider, from a list of other providers, for which analytics and/or aggregate analytics are to be created by application server 140 and/or obtained from database 145, and/or transmitted by application server 140, to provider server 120, for display via user interface 1000.

Remove provider button 1035 may, when selected by the provider, cause a window and/or field to be displayed, via user interface 1000, that enables the provider to select analytics, parameters, and/or information identifying a provider (e.g., displayed via trend 1010) to be removed from user interface 1000.

Weighting factors button 1040 may, when selected by the provider, enable the provider to set and/or change values for a first weighting factor (e.g., W1) and/or a second weighting factor (e.g., W2) as such weighting factors are described above with respect to FIG. 7. Changing the weighting factors may cause application server 140 to recomputed first weighted scores, second weighted scores, and/or total weighted scores associated with analytics displayed via user interface 1000.

Time period button 1045 may, when selected by the provider, enable the provider to set and/or change the time period for which the analytics have been created and/or computed by application server 140. The change in time period may cause application server 140 to obtain and/or create updated analytics and/or aggregate analytics, based on the changed time period, for display via user interface 1000.

The foregoing description provides illustration and description, but is not intended to be exhaustive or to limit the implementations to the precise form disclosed. Modifications and variations are possible in light of the above teachings or may be acquired from practice of the embodiments.

While series of blocks have been described with regard to FIGS. 4, 6A, 7, and 9, the order and/or timing of the blocks is not intended to be limiting and may be modified in other implementations. Further, non-dependent blocks may be performed in parallel, concurrently, substantially concurrently, and/or in a different order. Additionally, or alternatively, in other implementations, the processes described with regard to FIGS. 4, 6A, 7, and 9 may include additional elements, less elements, modified elements, and/or different elements than shown in FIGS. 4, 6A, 7, and 9.

It will be apparent that systems and methods, as described above, may be implemented in many different forms of software, firmware, and hardware in the implementations illustrated in the figures. The actual software code or specialized control hardware used to implement these systems and methods is not limiting of the implementations. Thus, the operation and behavior of the systems and methods were described without reference to the specific software code—it being understood that software and control hardware can be designed to implement the systems and methods based on the description herein.

Further, certain portions, described above, may be implemented as a component or logic that performs one or more functions. A component or logic, as used herein, may include hardware, such as a processor, an ASIC, or a FPGA, or a combination of hardware and software (e.g., a processor executing software).

It should be emphasized that the terms comprises and comprising, when used in this specification, are taken to specify the presence of stated features, integers, steps or components but do not preclude the presence or addition of one or more other features, integers, steps, components or groups thereof.

Even though particular combinations of features are recited in the claims and/or disclosed in the specification, these combinations are not intended to limit the disclosure of the embodiments. In fact, many of these features may be combined in ways not specifically recited in the claims and/or disclosed in the specification. Although each dependent claim listed below may directly depend on only one other claim, the disclosure of the embodiments includes each dependent claim in combination with every other claim in the claim set.

No element, act, or instruction used in the present application should be construed as critical or essential to the implementations unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A server device comprising:
one or more processors executing one or more instructions to:
receive, from a user device, a request to provide feedback, the feedback including information associated with an opinion of a user, of the user device, in connection with a particular product, a particular service, or a particular provider,
obtain, based on receiving the request, information associated with a plurality of providers,
output, to the user device, the information, associated with the plurality of providers, to enable the user to select a provider, of the plurality of providers, to which the feedback is to be transmitted,
receive, from the user device and based on outputting the information associated with the plurality of providers, information that identifies a selection of the provider, and
output the feedback to a different server device associated with the selected provider based on the information that identifies the selection of the provider.

2. The server device of claim 1, where, when obtaining the information associated with the plurality of providers, the one or more processors are further to:
obtain, based on the request, information identifying a geographic location of the user device,
identify, based on the information identifying the geographic location of the user device, the plurality of providers that are located within proximity of the geographic location of the user device, and
output, to the user device, the information associated with the plurality of providers that are located within proximity of the geographic location of the user device.

3. The server device of claim 1, where, when obtaining the information associated with the plurality of providers, the one or more processors are further to:
obtain, based on the request, information that includes a term with which to perform a search to identify the plurality of providers,
obtain, based on the information that includes the term, the information associated with the plurality of providers, that includes at least one term that matches the term, and
output, to the user device, the information associated with the plurality of providers that includes the at least one term that matches the term.

4. The server device of claim 1, where the one or more processors are further to:
process the feedback to identify a rating, by the user, of a particular product, a particular service, the particular provider, or information offered by the particular provider,
assign, to the feedback, a score based on the rating of the particular product, the particular service, or the information offered by the particular provider, the score corresponding to a measure or sentiment of the user in connection with the particular product, the particular service, the particular provider, or the information offered by the particular provider, and
output, to the particular server device, at least one of the feedback, the rating, or the score.

5. The server device of claim 1, where the one or more processors are further to:
process the feedback to identify a first keyword that describes the opinion, of the user, in connection with the product, the service, or the selected provider,
compare the first keyword to a plurality of second keywords associated with previously obtained measures of sentiment in connection with one or more products, one or more services, or one or more of the plurality of providers,
the previously determined measures of sentiment corresponding to at least a positive measure of sentiment or a negative measure of sentiment,
identify a second keyword, of the plurality of second keywords, that matches the first keyword, the second keyword corresponding to a measure of sentiment, of the user, in connection with the product, the service, or the selected provider, and
output, to the different server device, at least one of the feedback, the first keyword, the second keyword, or the level of sentiment.

6. The server device of claim 1, where the one or more processors are further to:
process the feedback to identify a rating and a measure of sentiment,
the rating corresponding to an objective opinion, of the user, based on a user-specified quantitative value in connection with the product, the service or the selected provider, and
the measure of sentiment corresponding to a subjective opinion, of the user, based on one or more user-specified terms in connection with the product, the service, or the provider,
assign a first score to the product, the service, or the provider based on the rating,
assign a second score to the product, the service, or the provider based on the measure of sentiment, and
output, to the different server device, at least one of the feedback, the first score, or the second score.

7. A system comprising:
one or more server devices executing one or more instructions to:
receive, from a user device, a request to provide feedback, the feedback including information associated with an opinion of a user, of the user device, in connection with a product, a service, or a provider of products or services,
obtain, based on the request, information identifying a location associated with the user device;
retrieve information associated with a plurality of providers that are located within proximity of the location of the user device, based on the information identifying the location of the user device;
output, to the user device, the information associated with the plurality of providers;
receive, from the user device, feedback associated with a selected provider, of the plurality of providers, the selected provider being selected, by the user; and
output the feedback to a different server device associated with the selected provider.

8. The system of claim 7, where the one or more server devices are further to:
process the feedback to identify a first rating, the first rating corresponding to an objective opinion, of the user, in connection with the product, the service, or the selected provider,
assign a first score to the feedback based on the first rating, and
output, to the different server device, at least one of the feedback, the rating, or the first score.

9. The system of claim 8, where the one or more server devices are further to:
receive, from a different user device, different feedback associated with the selected provider, the different feedback being provided by a different user of the different user device,
process the different feedback to determine a second rating, the second rating corresponding to an objective opinion, of the different user, in connection with the product, the service, or the selected provider,
assign a second score, to the different feedback, based on the second rating,
determine a third score, based on a combination of the first score and the second score; and
output, to the different server device, feedback analytics that include on at least one of:
the feedback,
the first rating,
the first score,
the different feedback,
the second rating,
the second score, or
the combined score.

10. The system of claim 8, where the one or more server devices are further to:
receive, from the different server device, a different request for aggregate feedback associated with a first provider, the first provider being a peer provider that is associated with a same or similar industry as the selected provider,
obtain information associated with second feedback in connection with a second product, a second service or the first provider, the information, associated with the second feedback, including at least one of the second feedback, a second rating associated with the second feedback, or a second score based on the second rating,
determine whether the first score is greater than the second score, and
output, to the different server device, a first indication that the selected provider is performing at a higher level than the first provider when the first score is greater than the second score.

11. The system of claim 10, where the one or more server devices are further to:
output, to the different server device, a second indication that the selected provider is not performing at the higher level than the first provider when the first score is not greater than the second score.

12. The system of claim 7, where the one or more server devices are further to:
receive, from the different server device, a request for aggregate feedback associated with a first provider and a second provider, the first provider and the second provider being owned or controlled by the selected provider;
obtain first information that includes feedback associated with the first provider, the first information including one or more first scores associated with a rating or a measure of sentiment associated with a first product offered by the first provider, a first service offered by the first provider, or the first provider,
obtain second information that includes feedback associated with the second provider, the second information including one or more second scores associated with a rating or a measure of sentiment associated with a second product offered by the second provider, a second service offered by the second provider, or the second provider,
determine whether a first value, associated with a combination of the one or more first scores, is greater than a second value associated with a combination of the one or more second scores, and
output, to the different server device, a first indication that the first provider is performing at a higher level than the second provider when the first value is greater than the second value.

13. The system of claim 12, where the one or more server devices are further to:
output, to the different server device, a second indication that the first provider is not performing at a higher level than the first provider when the first value is not greater than the second value.

14. A method performed by a first server device executing one or more instructions, the method comprising:
receiving, by the first server device and from a user device, a request to provide feedback to a second server device associated with a provider that offers a service or a product;
obtaining, by the first server device and based on the request, a first term associated a particular provider or information identifying a location associated with the user device;
obtaining, by the first server device, information associated with a plurality of providers that include a second term that matches the first term or that are located within a geographical area in which the location of the user device is located;
transmitting, by the first server device and to the user device, the information associated with the plurality of providers that are located within the geographical location;
receiving, by the first server device and from the user device, feedback associated with a selected provider, of the plurality of providers, the feedback describing an opinion of the user with respect to the product or the service;
processing, by the first server device, the feedback to identify at least one of:
a rating of the product or the service that is provided by the user and is included within the feedback, or
one or more keywords, describing the product or the service, that are included within the feedback that match at least one other keyword stored in a memory associated with the first server device, the at least one other keyword describing a sentiment, of the user, with respect to the product or the service;
assigning, by the first server device, one or more scores to the feedback based on the rating or a quantity of the one or more keywords that match the at least one other keyword;
transmitting, by the first server device and to the second server device, at least one of:
the feedback,
the one or more scores, or
the quantity of one or more keywords.

15. The method of claim 14, further comprising:
receiving, by the first server device and from the second server device, a particular request to provide aggregate analytics based on feedback previously received from a plurality of user devices;
obtaining, by the first server device and based on receiving the particular request, first feedback previously received by the first server device that is directed to the second server device;
obtaining, by the first server device and based on obtaining the first feedback, second feedback previously received by the first server device that directed to a third server device, the third server device being associated with a different provider that is at least one of:
a subsidiary of the provider,
an entity that owns the provider,
a competitor of the provider, or
a partner of the provider; and
transmitting, by the first server device and to the second server device, the first feedback or the second feedback.

16. The method of claim 15, where obtaining the first feedback further includes:
processing the first feedback to create first analytics, the first analytics identifying at least one of:
a first rating that describes an objective opinion of the user based on a user-specified quantitative first value associated with the product or the service, or
a first level of sentiment of the user, based on one or more user-specified keywords that describe a subjective opinion of the user in connection with the product or the service; and
where obtaining the second feedback further includes:
processing the second feedback to create second analytics, the second analytics identifying at least one of:
a second rating that describes an objective opinion of a different user of a different user device based on a quantitative second value associated with a different product or a different service offered by the different provider, or
a second level of sentiment of the different user, based on one or more user-specified keywords that describes a subjective opinion of the different user in connection with the different product or the different service, and
transmitting, by the first server device and to the second server device aggregate analytics that include at least one of:
the first feedback,
the first analytics,
the second feedback, or
the second analytics.
